(19) United States
(12) Patent Application Publication
(10) Pub. No.: US 2025/0378695 A1
(43) Pub. Date: Dec. 11, 2025

(54) METHOD FOR PROVIDING A GEOMETRIC REPRESENTATION OF A TRAFFIC LINE MARKING

(71) Applicant: Robert Bosch GmbH, Stuttgart (DE)

(72) Inventors: Maximilian Pittner, Erlangen (DE); Alexandru Paul Condurache, Renningen (DE); Joel Janai, Leonberg (DE)

(21) Appl. No.: 19/222,015

(22) Filed: May 29, 2025

(30) Foreign Application Priority Data
Jun. 7, 2024 (DE) 10 2024 205 245.0

(51) Int. Cl. G06V 20/56; G06V 10/766; G06V 10/77; G06V 10/82

(52) U.S. Cl. CPC G06V 20/588; G06V 10/766; G06V 10/7715; G06V 10/82

(57) ABSTRACT

A method for providing a geometric representation of a traffic line marking. A computer program, an apparatus, and a storage medium are also described.

### CROSS REFERENCE

The present application claims the benefit under 35 U.S.C. § 119 of German Patent Application No. DE 10 2024 205 245.0 filed on Jun. 7, 2024, which is expressly incorporated herein by reference in its entirety.

### FIELD

The present invention relates to a method for providing a geometric representation of a traffic line marking. The present invention also relates to a computer program, an apparatus and a storage medium for this purpose.

### BACKGROUND INFORMATION

A major challenge in the automatic detection of traffic lines and lane markings is that, in complex environments (the urban space), lanes can take on courses and shapes that have to be precisely modeled by the detection algorithm. For deep learning-based methods, this raises the question of how the geometry of the lane can be represented internally in the network and learned using the available ground truth. One important design decision for neural networks is therefore the way in which to-be-detected traffic lines are represented in the network (line representation). Most methods are based on discrete anchor or key point, or grid representations. A disadvantage of these discrete representations is that predefined fixed points in the image (for 2D detection) or in the 3D space (for 3D detection) describe the geometry of a continuous curve. The accuracy of the detection is therefore highly dependent on the predetermined position and number of these points. A further disadvantage is that complex post-processing by clustering and/or curve fitting is required to obtain a smooth and continuous curve from the discrete representation, which has a negative impact on the runtime of the algorithm.

Some methods, on the other hand, use parametric representations, in which a continuous curve is described directly by the parameters of a mathematical function. In the field of 2D lane detection, for example, polynomials or Bézier curves are considered possible functions.

### SUMMARY

The present invention includes a method, a computer program, an apparatus, and a computer-readable storage medium. Features and details of the present invention will emerge from the disclosure herein. Features and details which are described in connection with the method according to the present invention will of course also apply in connection with the computer program according to the present invention, the apparatus according to the present invention and the computer-readable storage medium according to the present invention and vice versa, so that mutual reference is always possible with respect to the disclosure of the present invention.

The present invention is in particular includes a method for providing a geometric representation of a traffic line marking. According to an example embodiment of the present invention, the method includes the following steps, wherein the steps can be carried out repeatedly and/or successively. The traffic line marking is a lane marking on a road, for instance, which delimits the lane to the outside and/or to another lane. The traffic line marking can be a solid line or also a line with interruptions, such as a broken line.

In a first step, a feature map is preferably provided, wherein the feature map comprises extracted features that have been extracted based on at least one respective image of a traffic scene with the traffic line marking. The at least one image can result from an acquisition by at least one sensor, such as a camera, radar, LiDAR or ultrasonic sensor. The extracted features are in particular specific to the traffic line marking in the at least one respective image. The feature map preferably represents a plan view onto the traffic scene with the traffic line marking and comprises a plurality of cells, wherein the extracted features are assigned to the plurality of cells. The cells can be two-dimensional cells, so that, in simplified terms, the feature map represents a grid with the plurality of two-dimensional cells, wherein each individual cell is assigned corresponding extracted features. The feature map can be subtended in a Cartesian coordinate system. The extraction of the features can be carried out using a machine learning model. The machine learning model can extract features from the at least one image by dividing the at least one image into a series of pixels and then analyzing the intensity and color information of each pixel. The machine learning model can then recognize patterns in this information and identify those patterns as features. This process is carried out by a combination of convolutional neural networks (CNN) and deep learning algorithms, for instance, that are configured to recognize and classify complex patterns in images. As part of providing, the at least one image can first be processed in a sensor perspective, or in particular a front view, in order to provide a feature map of the sensor perspective. The feature map of the sensor perspective can then be transformed into the feature map of the plan view. The transformation into the feature map of the plan view can be implemented using inverse perspective mapping (IPM).

In a further step, at least one initial line suggestion for the traffic line marking is preferably defined, wherein a shape of the initial line suggestion is described by line parameters. The initial line suggestion can have any shape and orientation, and is, for example, a straight line.

In a further step, the at least one defined initial line suggestion is preferably assigned to individual cells in the feature map. In other words, this in particular involves determining how the defined initial line suggestion should run through the provided feature map.

In a further step, line parameters of the geometric representation of the traffic line marking are preferably predicted based on the line parameters of the at least one line suggestion and the respective extracted features in the individual cells to which the at least one line suggestion has been assigned. The line parameters of the geometric representation in particular determine a shape or a course of said line by means of the feature map, or the Cartesian coordinate system, in which the feature map is subtended.

In a further step, the geometric representation of the traffic line marking is preferably provided based on the predicted line parameters.

As part of the prediction, control points of the geometric representation are determined based on a deviation of the control points from initial control points of the line suggestion in two directions orthogonal to the at least one line suggestion. This can have the advantage of achieving greater accuracy and efficiency in the prediction of the geometric representation. Determining the control points in orthogonal directions makes it possible to acquire deviations in only these two dimensions, which can lead to an improved adaptation to the desired shape. One advantage of the restriction to two degrees of freedom is in particular the avoidance of ambiguities. This means that only one configuration of control points is possible for a specific curve progression, which can in turn greatly simplify the estimation and the learning process.

The method according to the present invention advantageously makes it possible to provide a more precise geometric representation of traffic line markings and even depict more complicated or unusual courses of traffic line markings.

It is also possible that the feature map represents a plan view onto the traffic line marking in a three-dimensional coordinate system and that the geometric representation of the traffic line marking models it as a spatial curve in the three-dimensional coordinate system for all three directional components of the three-dimensional coordinate system.

Advantageously, an example embodiment of the present invention can provide that a mathematical formulation of the geometric representation parameterizes a three-dimensional curve, wherein a curve argument is defined in the interval [0, 1] and three-dimensional control points are used, wherein each three-dimensional control point weights a respective B-spline basis function representing a recursive polynomial, wherein a sum of the weighted B-spline basis functions yields the three-dimensional curve. A B-spline basis function is in particular a mathematical function that is used to model curves and surfaces. It is in particular based on the use of polynomials and node vectors to create a smooth and continuous curve or surface. B-spline basis functions are preferably set up to be locally limited, i.e. each function affects only a limited region of the curve or surface in particular. This can advantageously make them very effective for modeling complex shapes. A recursive polynomial is in particular a polynomial in which the coefficients depend on previous values of the polynomial. This means that the calculation of the polynomial for a specific value may depend on one or more previous values. A corresponding recursive formula can be used to calculate the polynomial. For unchanged basis functions and node vectors, the control points alone preferably determine the course of the curve or surface.

Specifically, the mathematical formulation of the geometric representation is in particular given by a curve argument t as follows:

$$f ( t ) = ( \begin{matrix}x ( t ) \\ y ( t ) \\ z ( t )\end{matrix} ) = {\sum }_{k = 1}^{K} {c}_{k} \cdot {B}_{k , d} ( t )$$

wherein t is defined in the interval [0, 1] and K control points cₖ=(xₖ, yₖ, zₖ)^{T} are used, wherein each control point weights a respective B-spline basis function B_{k,d}(t) which represents a recursive polynomial of degree d, wherein a sum of the weighted B-spline basis functions yields the three-dimensional curve.

It can advantageously also be provided that, as part of providing the feature map, the at least one image is processed in a sensor perspective, or in particular a front view, by a first component of a machine learning model, in particular a backbone, to provide a feature map of the sensor perspective, wherein a second component transforms the feature map of the sensor perspective into the feature map of the plan view and the prediction is carried out by a third component of the machine learning model, in particular a detection head. The sensor perspective can also be referred to and understood as a camera perspective if the at least one sensor used to provide the at least one image is a camera sensor. The sensor perspective in particular reflects the view from the perspective of this at least one sensor that is being used.

According to an example embodiment of the present invention, it can optionally be provided that, as part of a training, the machine learning model learns a regression task for a shape determination of the traffic line marking, wherein the machine learning model learns displacements in an x-y plane and in z-direction orthogonal to a respective initial line suggestion as part of the training for a respective reference line marking. Simply put, the machine learning model can learn how to determine the shape of the traffic line marking by carrying out the regression task. The machine learning model in particular learns how to move the lines in different planes by using points at corresponding locations in the curve function. The control points are preferably moved in such a way that the points at the corresponding locations in the curve function are aligned with the points present in the reference line marking. A regression task in the context of machine learning refers in particular to a type of supervised learning in which an algorithm is trained to predict a continuous output variable based on input variables. The objective of the regression task is preferably to find a mathematical function that describes the relationship between the input variables and the target variable. The input variables are preferably adjusted in such a way that a predefined cost function is minimized. In the context of the present invention, the costs are specifically in particular the distances between points in the reference line and the corresponding points in the curve function.

In other words, in particular points that are labeled in the reference line marking (ground truth) are projected orthogonally onto the respective initial line suggestion. This thus yields the locations in the curve function of the line suggestion, or more precisely in particular the corresponding curve arguments of the curve function. At these locations, the curve function of the predicted line suggestion is preferably evaluated and the distances to the points are calculated in the reference line marking. These distance values then in particular form the regression costs.

It can optionally be possible that, as part of the training, each point is first projected orthogonally onto the respective line suggestion predicted as part of the training in order to determine a corresponding curve argument for each point of the reference traffic line marking.

It is further optionally provided that a number of degrees of freedom of a respective control point is reduced to two and in each case only one translation of an initial control point in an x-y plane and in z-direction is learned as part of the training. A regression of three parameters per control point during training can lead to deterioration of generalization (overfitting). In general, this can lead to a deteriorated estimation and a more difficult learning behavior, which results in poorer generalization. This problem can advantageously be solved by limiting the number of degrees of freedom to two.

It is possible for the method according to the present invention to be used in a vehicle. According to an example embodiment of the present invention, it can be provided that the provided geometric representation is used as part of an at least partially automated driving function of a vehicle, such as a lane keeping assist system, wherein the at least one image of the traffic scene with the traffic line marking results from an acquisition by at least one sensor of the vehicle. The at least one surroundings sensor can, for example, be a camera sensor, a radar sensor, a LIDAR sensor or also an ultrasonic sensor. Accordingly, the at least one image can be a camera image, or also a radar, LIDAR or ultrasonic image. The geometric representation can initially provide an improved depiction and thus an improved prediction of traffic line markings. This improved prediction can in turn be used as part of the surroundings perception of the vehicle for the at least partially automated driving functions. The vehicle can be a motor vehicle and/or a passenger vehicle and/or an autonomous vehicle, for instance. The vehicle can comprise a vehicle device, for example for providing an autonomous driving function and/or a driver assistance system. The vehicle device can be configured to at least partially automatically control and/or accelerate and/or brake and/or steer the vehicle.

It can also be provided according to an example embodiment of the present invention that the method further comprises the following step:
defining a region function that indicates whether a respective region of the traffic line marking is visible in the at least one image, wherein a shape of the region function is determined by the predicted line parameters.

The region function can be depicted by B splines having the same basis functions and node vectors as the geometric representation, for example. A variety of parametric functions are generally possible for depicting the region function. For example, it would also be possible to depict the region function as dashed lines using sine functions. Since each traffic line marking can extend across different regions, can have different lengths, and different regions can be present or visible or absent or not visible or obscured, it is in particular useful to define the additional region function v(t). This preferably indicates whether a region of the traffic line marking is present or visible or not. Like the geometric curve function, the region function, too, can be depicted by B-splines with the same basis functions and node vectors. Other continuous functions such as the sine function could also be used to depict the visible segments of a broken line. The sine function can be suitable for such cases because of its periodicity and in particular because only a few parameters need to be learned. Its shape is then determined only by the additional line parameters to be predicted by the machine learning model, for example, or in particular the control points γₖ. The region function is then in particular defined as follows:

$$v ( t ) = {\sum }_{k = 1}^{K} {γ}_{k} \cdot {B}_{k , d} ( t )$$

Since it can be useful to model the region function as a probability function, the region function can be normalized using a sigmoid function σ(x), which results in the normalized region function σ(v(t)) with values between 0 and 1. The value of the continuous normalized region function σ(v(t)) at the location t can then be interpreted as a probability value that the corresponding traffic line is present or visible at the location t or not. Regions in the region function with values σ(v(t))>0.5 can therefore be considered present or visible; regions with values σ(v(t))≤0.5 can be considered absent or not visible or obscured. The machine learning model can use the prediction of the control points γₖ to estimate the presence or visibility of the regions.

A method according to an example embodiment of the present invention, which is described in the following, can be used to predict the region function. Since the task of estimating the presence or visibility of individual regions can be viewed as a binary classification problem, a binary cross-entropy can be used. Analogous to the procedure for the regression task, the corresponding curve argument tₚ for each point in the ground truth p is preferably determined. Each point p can be projected orthogonally onto the line suggestion. Each point in the ground truth p is preferably assigned a value \hat{v}ₚ that indicates whether the corresponding point is present or visible (\hat{v}ₚ=1) or not (\hat{v}ₚ=0). For a line i, its ground truth points p⁽ⁱ⁾, its associated values

$${\hat{v}}_{p}^{( i )}$$

and the corresponding points of the predicted region function v⁽ⁱ⁾(tₚ), the parameters of which are output by the machine learning model, the classification cost function per line suggestion using binary cross-entropy is in particular defined as follows:

$${ℒ}_{υ is}^{( i )} = - \frac{1}{\vert {𝒫}_{GT}^{( i )} \vert} {\sum }_{p ∈ {𝒫}_{GT}^{( i )}} {\hat{υ}}_{p}^{( i )} \cdot log ( σ ( {υ}^{( i )} ( {t}_{p} ) ) ) + ( 1 - {\hat{υ}}_{p}^{( i )} ) \cdot log ( 1 - σ ( {υ}^{( i )} ( {t}_{p} ) ) ) .$$

Another subject matter of the present invention is a computer program, in particular a computer program product, comprising instructions that, when the computer program is executed by a computer, prompt said computer program to carry out the method according to the present invention. The computer program according to the present invention has the same advantages as those described in detail with reference to a method according to the present invention.

The present invention also relates to a data processing device which is configured to carry out the method according to the present invention. The apparatus can be a computer, for example, that executes the computer program according to the present invention. The computer can comprise at least one processor for executing the computer program. A non-volatile data memory can also be provided, in which the computer program can be stored and from which the computer program can be read by the processor for execution.

The present invention can also relate to a computer-readable storage medium, which comprises the computer program according to the present invention and/or instructions that, when executed by a computer, prompt said computer program to carry out the method according to the present invention. The storage medium is configured as a data memory such as a hard drive and/or a non-volatile memory and/or a memory card, for example. The storage medium can be integrated in the computer, for instance.

The method according to the present invention can moreover also be configured as a computer-implemented method. Alternatively or additionally, at least one of the disclosed method steps can be computer-implemented and/or carried out automatically.

Further advantages, features and details of the present invention will emerge from the following description, in which embodiment examples of the present invention are described in detail with reference to the figures. The features disclosed herein can each be essential to the present invention individually or in any combination.

### BRIEF DESCRIPTION OF THE DRAWINGS

FIG. 1 shows a schematic visualization of a method, a vehicle comprising a camera, an apparatus, a storage medium and a computer program according to embodiment examples of the present invention.

FIG. 2A shows a schematic illustration of a 3D spline representation according to the related art.

FIG. 2B shows a schematic illustration of a 3D spline representation according to embodiment examples of the present invention.

FIG. 3 shows a schematic illustration of a 3D depiction of the geometric representation according to embodiment examples of the present invention.

FIG. 4 show a schematic illustration of a visualization of different initial line suggestions according to embodiment examples of the present invention.

FIG. 5 shows a schematic illustration of a visualization of the point assignment of the reference traffic line marking for the curve argument of an initial line suggestion.

### DETAILED DESCRIPTION OF EXAMPLE EMBODIMENTS

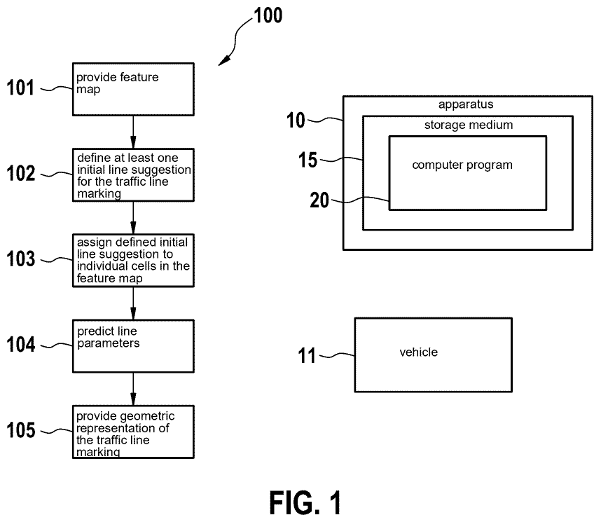

FIG. 1 schematically shows a method 100, a vehicle 11 comprising a sensor 12, an apparatus 10, a storage medium 15 and a computer program 20 according to embodiment examples of the present invention.

FIG. 1 in particular shows an embodiment examples of a method 100 for providing a geometric representation 1 of a traffic line marking. In a first step 101, a feature map 3 is provided, wherein the feature map 3 comprises extracted features that have been extracted based on at least one respective image of a traffic scene with the traffic line marking, wherein the extracted features are specific to the traffic line marking in the image, wherein the feature map 3 represents a plan view onto the traffic scene with the traffic line marking and comprises a plurality of cells 4, wherein the extracted features are assigned to the plurality of cells 4. In a second step 102, at least one initial line suggestion 2 for the traffic line marking is defined, wherein a shape of the initial line suggestion 2 is described by line parameters. In a third step 103, the at least one defined initial line suggestion 2 is assigned to individual cells 4 in the feature map 3. In a fourth step 104, line parameters of the geometric representation 1 of the traffic line marking are predicted based on the line parameters of the at least one line suggestion and the respective extracted features in the individual cells 4 to which the at least one line suggestion has been assigned. In a fifth step 105, the geometric representation 1 of the traffic line marking is provided based on the predicted line parameters. As part of the prediction 104, control points 5 of the geometric representation 1 are determined based on a deviation of the control points 5 from initial control points 5 of the line suggestion in two directions orthogonal to the at least one line suggestion.

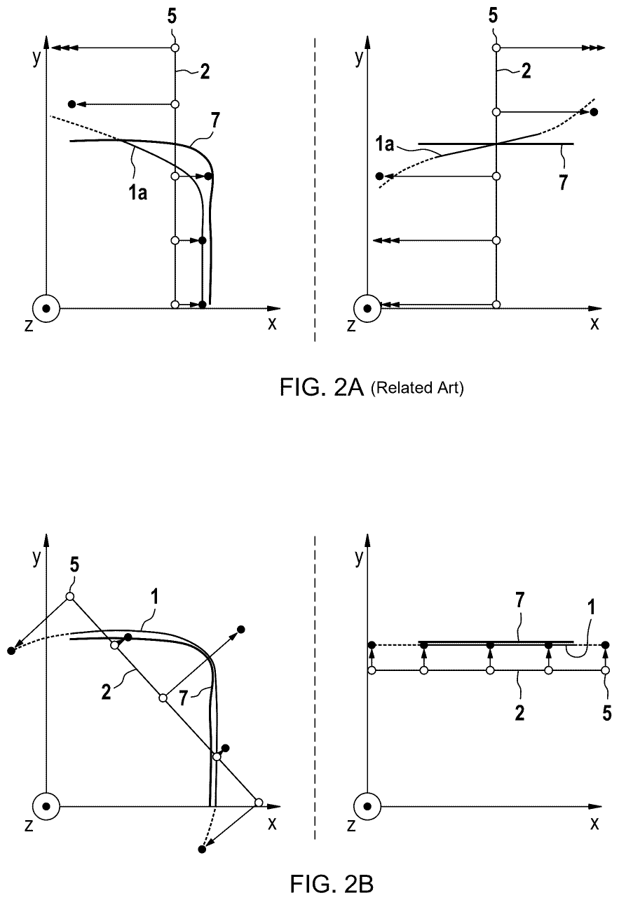

FIG. 2A and FIG. 2B show a comparison between already used 3D spline representation (FIG. 2A) and the here-described 3D spline representation according to embodiment examples (FIG. 2B) for different scenarios in plan view. Shown are the to-be-learned reference traffic line marking 7 or ground truth line, the initial line suggestion 2 and the geometric representation 1 ascertained using the method according to the related art (FIG. 2A) or the method according to the present invention (FIG. 2B). The points in particular depict spline control points 5 and the arrows show to-be-learned offsets orthogonal to the initial line suggestion 2. For representations already used in the related art 1a (see FIG. 2A), in which only the x- and z-components are modeled with splines, the line examples shown here are hardly or not at all modelable. For the geometric representation 1 according to the present invention, in which all three directional components are modeled as a spline function and different line suggestions 2 are possible, these scenarios can be represented and learned by a machine learning model.

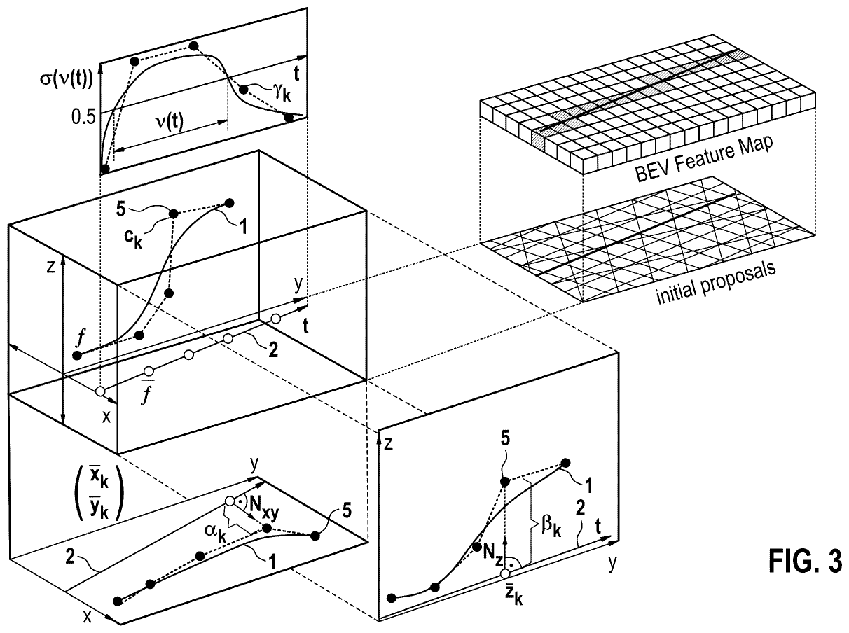

FIG. 3 schematically shows a 3D depiction of the geometric representation 1 according to embodiment examples. The figure shows the initial line suggestion 2 and the geometric representation 1 of the traffic line marking. The points in particular represent spline control points 5 and the arrows show orthogonal directions to the line suggestion with to-be-learned offsets αₖ, βₖ (distances of the control points to the control points of the initial line suggestion). Also shown is the region function v(t), which is described in detail in the following.

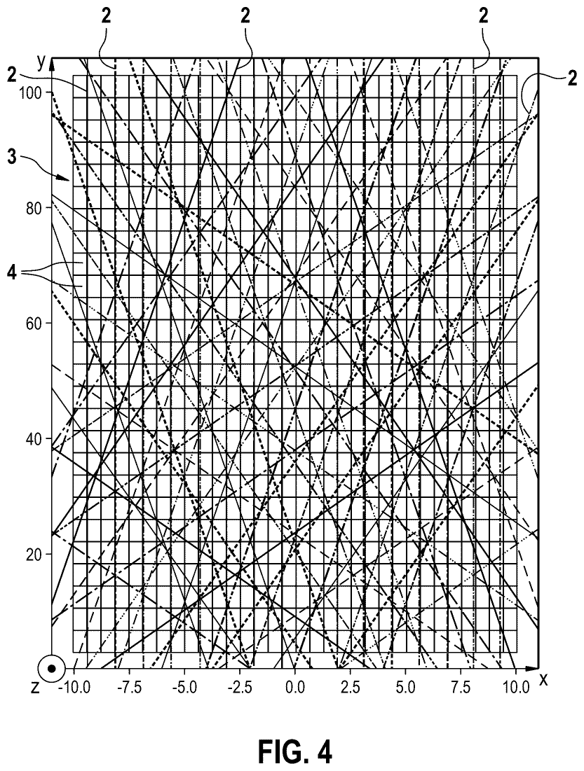

FIG. 4 shows a visualization of different initial line suggestions 2 according to embodiment examples in plan view. The geometric representation 1 according to embodiment examples in particular allows differently oriented initial line suggestions 2, which makes it possible to represent a wide variety of line progressions. The feature map 3 with the plurality of cells 4 is shown as well.

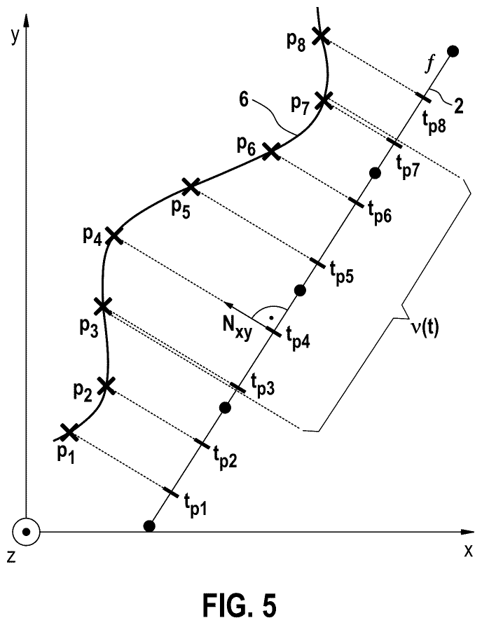

FIG. 5 shows a visualization of the point assignment of the reference traffic line marking 6 (ground truth) for the curve argument t of an initial line suggestion 2 according to embodiment examples in plan view. Ground truth points p₁ to p₅ of the reference traffic line marking 6 are preferably projected orthogonally onto an initial line suggestion, thus determining tₚ_{₁} to tₚ_{₅}. The dashed lines in particular show distances between the ground truth and the initial line suggestion 2, which can be minimized by the regression cost function as part of a training. Also shown is the region function v(t), which is described in detail in the following.

The present invention is in particular based on an approach for deep learning-based 3D detection of traffic line markings. According to embodiment examples, the method serves to improve existing methods for 3D line detection, which can be used for surroundings perception for driver assistance systems (partially to fully automated driving functions). Since, according to embodiment examples, the present invention is based on a camera-based detection method, in particular at least one camera sensor is needed as the sensor which is mounted on the vehicle and is directed to the front. Generally, the method is not limited to a single camera and can also use multiple camera sensors as well as non-imaging sensors such as LIDAR or RADAR. When using additional sensors, it is in particular only necessary to know the respective extrinsic parameters in order to transform feature maps extracted by the machine learning model, in particular by the backbone of the machine learning model, into a common reference coordinate system. For non-imaging sensors, a sensor-specific backbone may also be needed. For the sake of simplicity, only the case of using a single sensor is described in the following.

The data recorded by the sensor are preferably processed by a computing unit on which the method according to embodiment examples can also be implemented as software. The present invention is in particular based on learning-based detection methods that use machine learning models, particularly neural networks, for line detection. Since the machine learning models, or neural networks, used here can be trained on (preferably large) data sets, image data recorded by a sensor as described above is required, for example. The image data may also require labels that describe the so-called true 3D geometry (ground truth) of the traffic line markings visible in the at least one respective image. This description of the 3D geometry of an individual line instance can, for example, be realized as an ordered list of 3D point coordinates (polyline).

The underlying neural network in particular directly estimates the control points of the spline function, thus completely describing the geometry of the to-be-detected line.

While the parametric continuous line representations offer significant advantages over discrete representations, the solutions used to date for B-spline-based 3D lane detection are, for instance, not entirely sufficient to detect any random lanes and lines. The reason for this is in particular that the spline-based representations used to date only model the lateral x (left/right) and vertical z deflection (height) of the lane with splines, while the longitudinal y-component (direction of travel) forms the curve argument of the spline functions. The result of this can be that only lines that increase monotonically along the direction of travel are depicted. More complex structures with sharp curves, some of which are nearly perpendicular to the direction of travel, are hardly or only theoretically depictable—and therefore difficult for the machine learning model to learn. More complex structures, such as those that include horizontal lines, can by definition of the line representation not be depicted and can therefore also not be learned by the machine learning model (see FIG. 2).

While conventional parametric 3D line representations are limited in terms of their capacity and are not capable of accurately describing arbitrary curve progressions, the present invention according to embodiment examples describes a new spline-based line representation with which the machine learning model can depict and learn any curve progressions.

The present invention according to embodiment examples, for instance, provides the following advantages over conventional methods. In contrast to conventional spline-based methods, in which only the x- and z-components are modeled with a function, the method described here in particular enables lines to be represented as actual 3D spatial curves, wherein the geometry of all three components can be modeled using splines. In contrast to conventional spline-based representations, which are limited to curves with a monotonic y-progression, the method described here in particular enables any line progression to be modeled and learned. This can also make it possible to model and learn horizontal lines, U-turns and other complex structures. This can also make it easier to learn frequently occurring structures with strong curve progressions. Since the present case in particular uses a parametric representation that models lines directly as continuous spatial curves, the same advantages over discrete formulations as described in the preceding section relating to the related art can additionally result here as well.

According to embodiment examples, one aspect of the present invention is a line representation for 3D lane and traffic line detection based on three-dimensional B-spline functions that can be applied largely independent of the architecture of the neural network being used. According to embodiment examples, another aspect is in particular a description of a detection head architecture that can be used in the machine learning model and can predict parameters for the line representation. Another aspect is in particular a learning method with which the machine learning model can learn from the existing ground truth the adjustments of the spline representation needed to accurately describe the to-be-detected line shapes and courses.

In conventional methods, in particular only the x- and z-components were modeled with parametric functions, and therefore only lines running monotonically in y-direction were represented. The present invention according to embodiment examples describes an approach in which all three components (x, y, z) are modeled with splines. The mathematical formulation of the representation is therefore in particular given as a 3D curve parameterized by a curve argument t as follows:

$$f ( t ) = ( \begin{matrix}x ( t ) \\ y ( t ) \\ z ( t )\end{matrix} ) = {\sum }_{k = 1}^{K} {c}_{k} \cdot {B}_{k , d} ( t )$$

with t defined in the interval [0, 1] and K control points cₖ=(xₖ, yₖ, zₖ)^{T}. Each control point preferably weights the respective B-spline basis function B_{k,d}(t), which depicts a recursive polynomial of the degree d. The sum of the weighted basis functions then preferably yields the 3D spline. Since the basis functions are fixedly defined and unchanging, the progression of the spline function and thus the shape of the 3D curve is influenced in particular exclusively by the control points. Due to the ambiguity of 3D splines (i.e. the same curve can be depicted by different arrangements of the control points), the regression of three parameters per control point during training can lead to severe deterioration of generalization (overfitting). This problem can be solved by reducing the number of degrees of freedom of a control point to 2 and learning only one translation of an initial control point in the x-y plane and in the y-z plane at a time (see FIG. 3). Stated more specifically, the directions defined by the degrees of freedom are in particular orthogonal to the initial line suggestion, as a result of which the initial control points cx are moved in the orthogonal directions N_{xy} and N_{z} (as shown in FIG. 3 with vectors). The control points are thus in particular defined as follows:

$${c}_{k} = ( \begin{matrix}{x}_{k} \\ {y}_{k} \\ {z}_{k}\end{matrix} ) = ( \begin{matrix}{\overline{x}}_{k} + {N}_{x} \cdot {α}_{k} \\ {\overline{y}}_{k} + {N}_{y} \cdot {α}_{k} \\ {\overline{z}}_{k} + {N}_{z} \cdot {β}_{k}\end{matrix} )$$

Nₓ preferably describes the x-component and N_{y} the y-component of N_{xy}. Consequently, in particular only two parameters are needed to determine a three-dimensional control point: αₖ for the displacement along N_{xy} in the x-y plane and βₖ for the displacement along N_{z} in z-direction. In order to cover as many different line shapes and courses as possible, a large number of different orientations are preferably used for the initial line suggestions f̅ (see FIG. 4). The machine learning model can also estimate the presence or geometry of the line by estimating the control point deviations αₖ and βₖ.

Since each traffic line marking can extend across different regions, can have different lengths, and different regions can be present or visible or absent or not visible or obscured, it is in particular useful to define an additional region function v(t). This preferably indicates whether a region of the traffic line marking is present or visible or not. Like the geometric curve function, the region function, too, can be depicted by B-splines with the same basis functions and node vectors. Other continuous functions such as the sine function could also be used to depict the visible segments of a broken line. The sine function can be suitable for such cases because of its periodicity and in particular because only a few parameters need to be learned. Its shape is then determined only by the additional control points γₖ to be predicted by the machine learning model, for example. The region function is then in particular defined as follows:

$$v ( t ) = {\sum }_{k = 1}^{K} {γ}_{k} \cdot {B}_{k , d} ( t )$$

Since it can be useful to model the region function as a probability function, the region function can be normalized using a sigmoid function σ(x), which results in the normalized region function σ(v(t)) with values between 0 and 1. The value of the continuous normalized region function σ(v(t)) at the location t can then be interpreted as a probability value that the corresponding traffic line marking is present or visible at the location t or not. Regions in the region function with values σ(v(t))>0.5 can therefore be considered present or visible; regions with values σ(v(t))≤0.5 can be considered absent or not visible or obscured. The machine learning model can use the prediction of the parameters or control points γₖ to estimate the presence or visibility of the regions.

The detection head of the machine model in particular operates on a feature map output by a preceding component of the machine model and represents the bird's-eye view (BEV) of the detection region. The individual line suggestions are preferably distributed over the plan view and can be assigned to the individual cells of the feature map. To learn similar features for each line suggestion, the machine model preferably uses a component for predicting the line parameters, which comprises a plurality of fully connected layers (FC layers) for which the weights for all of the line suggestions are shared. This can be achieved by feature selection (feature pooling), in which the feature cells along the course are selected for each line suggestion and the corresponding features are converted into a feature vector.

These feature vectors can then all be fed into the component with shared weights which outputs the parameters for line representation. To model the shape and progression of the to-be-detected lines, in particular K·2 parameters (or K·3 parameters in the event of additional prediction of the control points for the region function) are needed for each line suggestion. These parameters are preferably predicted by the detection head for each line suggestion. A probability value for the line existence pₚᵣ and a categorical probability distribution for the classification of the line category p_{cat} can be predicted for each line suggestion as well.

To detect the lanes and lane markings, the machine learning model can learn a variety of tasks. This includes classification tasks for determining the presence of a traffic line marking and its categorization, for example, as well as a regression task for determining the shape of the traffic line markings. A further task for predicting the region function can also be defined. A method according to embodiment examples of the present invention, which is described in the following, can be used for the regression task for determining the shape. Because the machine learning model is in particular supposed to learn displacements in the x-y plane and in z-direction orthogonal to the line suggestion, the corresponding locations in the curve function f(t) can be found for the points p⁽ⁱ⁾ that are present in the 3D line i. Stated more specifically, the corresponding curve argument tₚ is preferably determined for each point in the ground truth p. Each point p can be projected orthogonally onto the line suggestion as shown in FIG. 5. For a line i, its ground truth points p⁽ⁱ⁾ and the corresponding points of the predicted curve function f⁽ⁱ⁾(tₚ), the parameters of which are output by the machine learning model, the regression cost function per line suggestion is in particular defined as follows:

$${ℒ}_{reg}^{( i )} = \frac{1}{\vert {𝒫}_{GT}^{( i )} \vert} {\sum }_{p ∈ {𝒫}_{GT}^{( i )}} {\hat{υ}}_{p}^{( i )} \cdot {‖ w ⊙ ( {f}^{( i )} ( {t}_{p} ) - ( \begin{matrix}{\hat{x}}_{p}^{( i )} \\ {\hat{y}}_{p}^{( i )} \\ {\hat{z}}_{p}^{( i )}\end{matrix} ) ) ‖}_{1}$$

w is in particular a three-dimensional vector that scales each dimension, the indicator vₚ⁽ⁱ⁾∈{0, 1} indicates whether the 3D ground truth point p is visible or present in the at least one respective image and should therefore be considered for the cost, and

$${P}_{G T}^{( i )}$$

describes the amount of ground truth points for the line i.

The total costs are in particular calculated from the average of all regression costs of the M line suggestions:

$${ℒ}_{reg} = \frac{1}{M} {\sum }_{i = 1}^{M} {\hat{p}}_{pr}^{( i )} \cdot {ℒ}_{reg}^{( i )}$$

Preferably only line suggestions that are also present in the respective scenario are included in the cost function, which can be described with the indicator pₚᵣ⁽ⁱ⁾∈{0, 1}.

In the context of the present invention, bold and thin symbols in the given formulas are in particular intended to be distinguished such that bold symbols represent vectors and thin symbols represent scalars. Variables and unknown quantities are in particular written in italics. Vectors and matrices can also be written in italics, wherein vectors can additionally be shown with an arrow or in bold.

A method according to embodiment examples of the present invention, which is described in the following, can be used to predict the region function. Since the task of estimating the presence or visibility of individual regions can be viewed as a binary classification problem, a binary cross-entropy can be used. Analogous to the procedure for the regression task, the corresponding curve argument tₚ for each point in the ground truth p is preferably determined. Each point p can be projected orthogonally onto the line suggestion as shown in FIG. 5. Each point in the ground truth p is in particular assigned a value \hat{v}ₚ that indicates whether the corresponding point is present or visible (\hat{v}ₚ=1) or not (\hat{v}ₚ=0). For a line i, its ground truth points p⁽ⁱ⁾, its associated values

$${\hat{v}}_{p}^{( i )}$$

and the corresponding points of the predicted region function v\hat{v}ₚ(tₚ), the parameters of which are output by the machine learning model, the classification cost function per line suggestion using binary cross-entropy is in particular defined as follows:

$${ℒ}_{υ is}^{( i )} = - \frac{1}{\vert {𝒫}_{GT}^{( i )} \vert} {\sum }_{p ∈ {𝒫}_{GT}^{( i )}} {\hat{υ}}_{p}^{( i )} \cdot log ( σ ( {υ}^{( i )} ( {t}_{p} ) ) ) + ( 1 - {\hat{υ}}_{p}^{( i )} ) \cdot log ( 1 - σ ( {υ}^{( i )} ( {t}_{p} ) ) ) .$$

The total costs are in particular calculated from the average of all classification costs of the region functions for the M line suggestions:

$${ℒ}_{vis} = \frac{1}{M} {\sum }_{i = 1}^{M} {\hat{p}}_{pr}^{( i )} \cdot {ℒ}_{vis}^{( i )}$$

The above explanation of the embodiments describes the present invention solely within the scope of examples. Of course, individual features of the embodiments can be freely combined with one another, if technically feasible, without leaving the scope of the present invention.

What is claimed is:

1. A method for providing a geometric representation of a traffic line marking, the method comprising the following steps:
providing a feature map, the feature map including extracted features that have been extracted based on at least one respective image of a traffic scene with the traffic line marking, wherein the extracted features are specific to the traffic line marking in the at least one respective image, wherein the feature map represents a plan view onto the traffic scene with the traffic line marking and includes a plurality of cells, and wherein the extracted features are assigned to the plurality of cells;
defining at least one initial line suggestion for the traffic line marking, wherein a shape of the at least one initial line suggestion is described by line parameters;
assigning the at least one defined initial line suggestion to individual cells in the feature map;
predicting line parameters of the geometric representation of the traffic line marking based on the line parameters of the at least one initial line suggestion and the respective extracted features in the individual cells to which the at least one initial line suggestion has been assigned; and
providing the geometric representation of the traffic line marking based on the predicted line parameters;
wherein, as part of the prediction, control points of the geometric representation are determined based on a deviation of the control points from initial control points of the at least one initial line suggestion in two directions orthogonal to the at least one initial line suggestion.

2. The method according to claim 1, wherein the feature map represents a plan view onto the traffic line marking in a three-dimensional coordinate system and the geometric representation of the traffic line marking models it as a spatial curve in the three-dimensional coordinate system for all three directional components of the three-dimensional coordinate system.

3. The method according to claim 1, wherein a mathematical formulation of the geometric representation parameterizes a three-dimensional curve, wherein a curve argument is defined in an interval [0, 1] and three-dimensional control points are used, wherein each three-dimensional control point weights a respective B-spline basis function representing a recursive polynomial, wherein a sum of the weighted B-spline basis functions yields the three-dimensional curve.

4. The method according to claim 1, wherein, as part of providing the feature map, the at least one image is processed in a sensor perspective by a first component including a backbone of a machine learning model to provide a feature map of the sensor perspective, wherein a second component transforms the feature map of the sensor perspective into the feature map of the plan view and the prediction is carried out by a third component including a detection head of the machine learning model.

5. The method according to claim 4, wherein, as part of a training, the machine learning model learns a regression task for a shape determination of the traffic line marking, wherein the machine learning model learns displacements in an x-y plane and in z-direction orthogonal to a respective initial line suggestion as part of the training for a respective reference line marking.

6. The method according to claim 5, wherein, as part of the training, each point is first projected orthogonally onto the respective initial line suggestion predicted as part of the training in order to determine a corresponding curve argument for each point of the reference traffic line marking.

7. The method according to claim 5, wherein a number of degrees of freedom of each respective control point is reduced to two and in each case only one translation of an initial control point in an x-y plane and in a y-z plane is learned as part of the training.

8. The method according to claim 1, wherein the provided geometric representation is used as part of an at least partially automated driving function of a vehicle, wherein the at least one image of the traffic scene with traffic line marking results from an acquisition by at least one sensor of the vehicle.

9. The method according to claim 1, further comprising the following step:
defining a region function that indicates whether a respective region of the traffic line marking is visible in the at least one image, wherein the region function and a shape of the region function are determined by the predicted line parameters.

10. An apparatus for data processing, the apparatus configured to provide a geometric representation of a traffic line marking, the apparatus configured to:
provide a feature map, the feature map including extracted features that have been extracted based on at least one respective image of a traffic scene with the traffic line marking, wherein the extracted features are specific to the traffic line marking in the at least one respective image, wherein the feature map represents a plan view onto the traffic scene with the traffic line marking and includes a plurality of cells, and wherein the extracted features are assigned to the plurality of cells;
define at least one initial line suggestion for the traffic line marking, wherein a shape of the at least one initial line suggestion is described by line parameters;
assign the at least one defined initial line suggestion to individual cells in the feature map;
predict line parameters of the geometric representation of the traffic line marking based on the line parameters of the at least one initial line suggestion and the respective extracted features in the individual cells to which the at least one initial line suggestion has been assigned; and
provide the geometric representation of the traffic line marking based on the predicted line parameters;
wherein, as part of the prediction, control points of the geometric representation are determined based on a deviation of the control points from initial control points of the at least one initial line suggestion in two directions orthogonal to the at least one initial line suggestion.

11. A non-transitory computer-readable storage medium on which are stored instructions for providing a geometric representation of a traffic line marking, the instructions, when executed by a computer, causing the computer to perform the following steps:
providing a feature map, the feature map including extracted features that have been extracted based on at least one respective image of a traffic scene with the traffic line marking, wherein the extracted features are specific to the traffic line marking in the at least one respective image, wherein the feature map represents a plan view onto the traffic scene with the traffic line marking and includes a plurality of cells, and wherein the extracted features are assigned to the plurality of cells;
defining at least one initial line suggestion for the traffic line marking, wherein a shape of the at least one initial line suggestion is described by line parameters;
assigning the at least one defined initial line suggestion to individual cells in the feature map;
predicting line parameters of the geometric representation of the traffic line marking based on the line parameters of the at least one initial line suggestion and the respective extracted features in the individual cells to which the at least one initial line suggestion has been assigned; and
providing the geometric representation of the traffic line marking based on the predicted line parameters;
wherein, as part of the prediction, control points of the geometric representation are determined based on a deviation of the control points from initial control points of the at least one initial line suggestion in two directions orthogonal to the at least one initial line suggestion.
